(19) United States
(12) Patent Application Publication
(10) Pub. No.: US 2024/0326307 A1
(43) Pub. Date: Oct. 3, 2024

(54) CONTROL METHOD FOR INJECTION MOLDING SYSTEM AND INJECTION MOLDING SYSTEM

(71) Applicant: SEIKO EPSON CORPORATION, Tokyo (JP)

(72) Inventor: Yuji SHINBARU, MATSUMOTO-SHI (JP)

(21) Appl. No.: 18/621,146

(22) Filed: Mar. 29, 2024

(30) Foreign Application Priority Data
Mar. 30, 2023 (JP) 2023-055731

(51) Int. Cl. B29C 45/76; B29C 45/17; B29C 45/42; B29C 45/84

(52) U.S. Cl. CPC B29C 45/768; B29C 45/42; B29C 45/844; B29C 2045/1785; B29C 2045/4266; B29C 2945/76167; B29C 2945/76257

(57) ABSTRACT

A control method for an injection molding system including a first housing including a first accommodation space having an injection molding machine arranged therein and a first window, a second housing coupled to the first housing and having a second accommodation space having a robot disposed therein and a second window, the robot performs an operation with respect to a molded article molded by the injection molding machine, and a control device that controls driving of the injection molding machine and the robot, the control method includes in a first state in which the first window and the second window are closed, driving the injection molding machine in a first drive mode, in a second state in which the first window is open, stopping the injection molding machine, and in a third state in which the second window is open, driving the injection molding machine in a second drive mode.

### CROSS-REFERENCE TO RELATED APPLICATIONS

The present application is based on, and claims priority from JP Application Serial Number 2023-055731, filed Mar. 30, 2023, the disclosure of which is hereby incorporated by reference herein in its entirety.

### BACKGROUND OF THE INVENTION

### 1. Technical Field

The present disclosure relates to a control method for an injection molding system and to an injection molding system.

### 2. Related Art

JP-A2016-083823 discloses an injection molding system comprising an injection molding machine and a robot. In such an injection molding system, an injection molding machine includes a cover surrounding the operation range of the robot, and when the cover of the injection molding machine is opened, the operations of the robot and the injection molding machine are stopped. This ensures the safety of the injection molding system.

However, if the operation of not only the robot but also the injection molding machine is stopped when the injection molding machine cover is opened, the resin, which is the material in the injection molding machine, remains in the injection molding machine, the temperature of the resin deviates from an appropriate temperature range, the resin deteriorates, and the quality of a molded article after the operation of the injection molding machine is restarted may deteriorate. Therefore, in the injection molding system of JP-A2016-083823, it is difficult to achieve both safety and quality maintenance of the injection molding system.

### SUMMARY OF THE INVENTION

A control method for an injection molding system, the injection molding system having a first housing including a first accommodation space and a first window communicating with the first accommodation space, an injection molding machine arranged in the first accommodation space, a second housing coupled to the first housing, and having a second accommodation space communicating with the first accommodation space and a second window communicating with the second accommodation space, a robot that is disposed in the second accommodation space and that performs an operation with respect to a molded article molded by the injection molding machine, and a control device that controls driving of the injection molding machine and the robot, the control method for the injection molding system includes in a first state in which the first window and the second window are closed, driving the injection molding machine in a first drive mode, in a second state in which the first window is open, stopping the injection molding machine, and in a third state in which the second window is open, driving the injection molding machine in a second drive mode, wherein the second drive mode is different from the first drive mode.

An injection molding system includes a first housing having a first accommodation space and a first window communicating with the first accommodation space, an injection molding machine arranged in the first accommodation space, a second housing coupled to the first housing, and having a second accommodation space communicating with the first accommodation space and a second window communicating with the second accommodation space, a robot arranged in the second accommodation space and configured to perform an operation with respect to a molded article molded by the injection molding machine, and a control device that controls driving of the injection molding machine and the robot, wherein in a first state in which the first window and the second window are closed, the control device drives the injection molding machine in a first drive mode, in a second state in which the first window is open, the control device stops the injection molding machine, and in a third state in which the second window is open, the control device drives the injection molding machine in a second drive mode, wherein the second drive mode is different from the first drive mode.

### BRIEF DESCRIPTION OF DRAWINGS

FIG. 1 is a front view showing an injection molding system according to a first embodiment.

FIG. 2 is a plan view showing the inside of the injection molding system.

FIG. 3 is a cross-sectional view of the injection molding machine.

FIG. 4 is a cross-sectional view for explaining an operation of releasing a molded article from a mold.

FIG. 5 is a cross-sectional view for explaining an operation of releasing a molded article from a mold.

FIG. 6 is a cross-sectional view for explaining an operation of releasing a molded article from a mold.

FIG. 7 is a flowchart for explaining a control method of the injection molding system.

FIG. 8 is a cross-sectional view for explaining a control method of the injection molding system according to the second embodiment.

FIG. 9 is a cross-sectional view for explaining a control method of the injection molding system according to the second embodiment.

FIG. 10 is a cross-sectional view of an injection molding machine included in the injection molding system according to the third embodiment.

### DETAILED DESCRIPTION OF THE INVENTION

Hereinafter, a control method of an injection molding system and an injection molding system of the present invention will be described in detail based on preferred embodiments shown in the accompanying drawings.

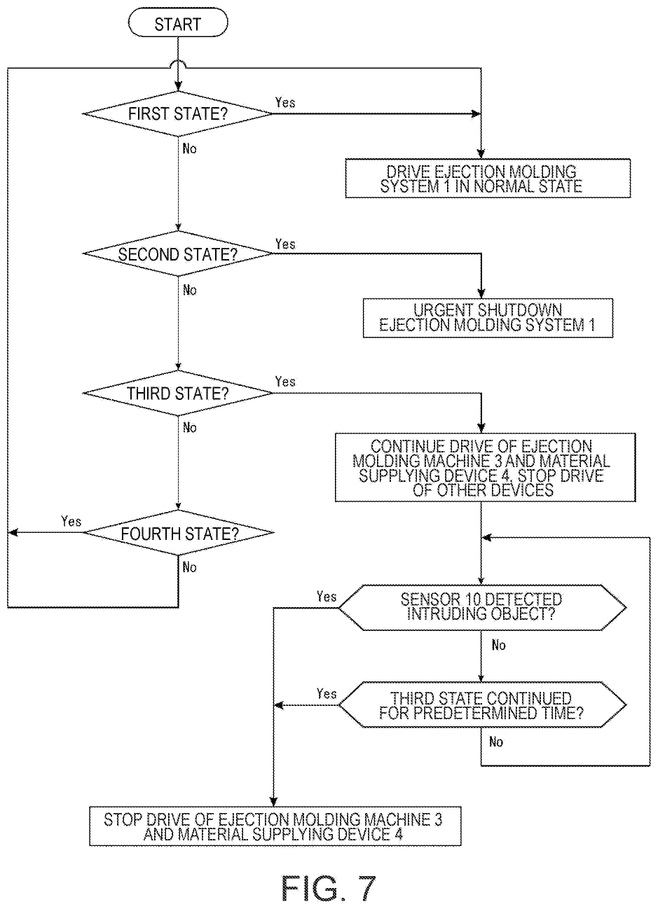

In addition, in each drawing except for FIG. 7, an X-axis, a Y-axis, and a Z-axis which are three axes orthogonal to each other are shown. Hereinafter, a direction along the X-axis is also referred to as an X-axis direction, a direction along the Y-axis is also referred to as a Y-axis direction, and a direction along the Z-axis is also referred to as a Z-axis direction. The arrow side of each axis is also referred to as a “plus side”, and the side opposite to the arrow is also referred to as a “minus side”. The Z-axis direction plus side is also referred to as “up” and the minus side is referred to as “down”.

### First Embodiment

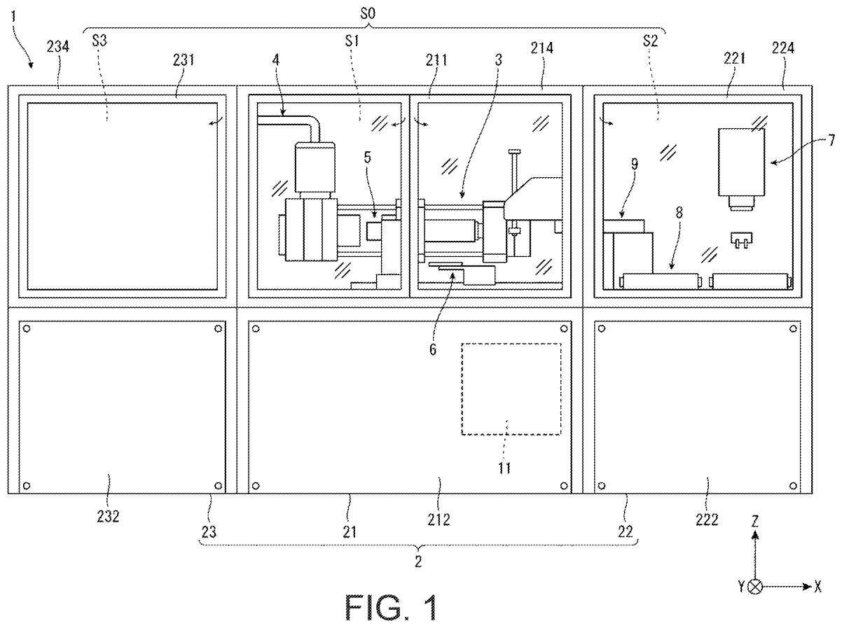

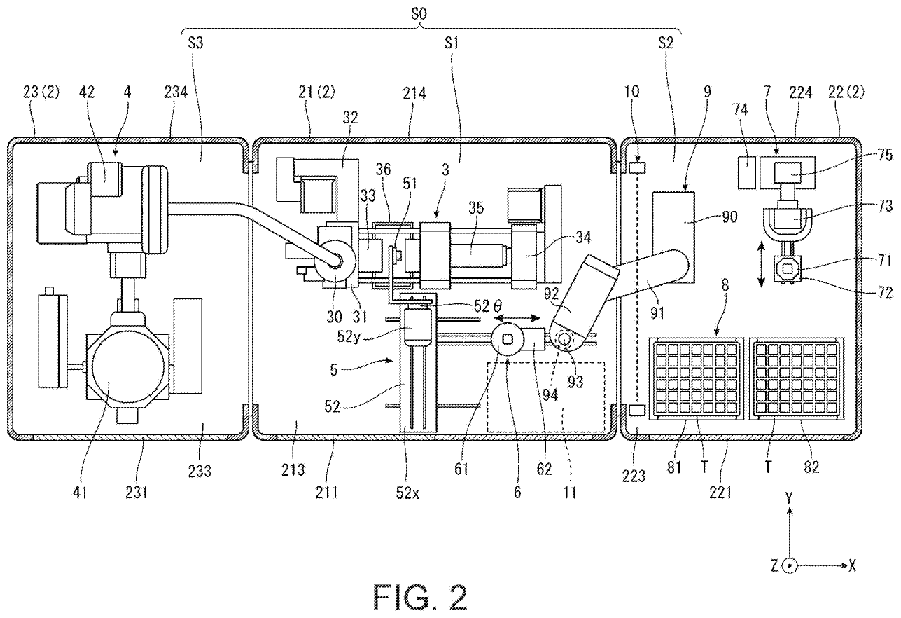

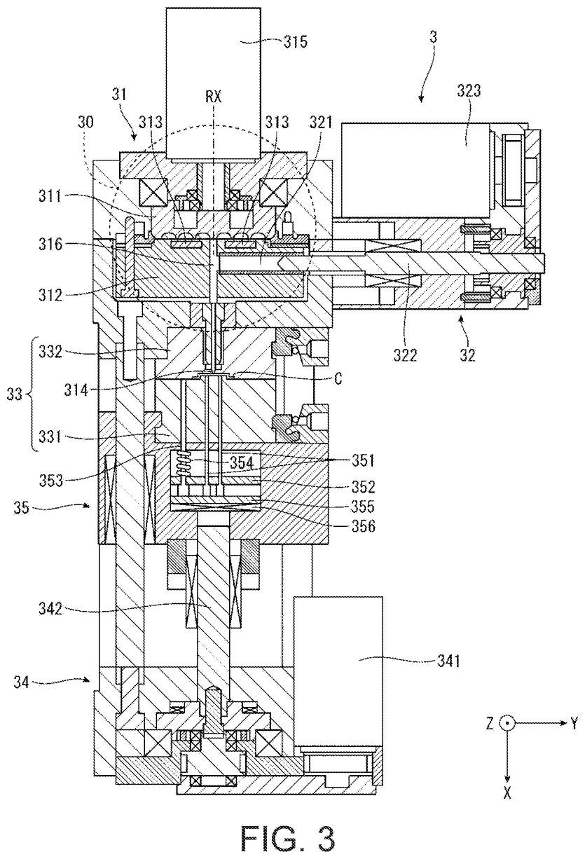

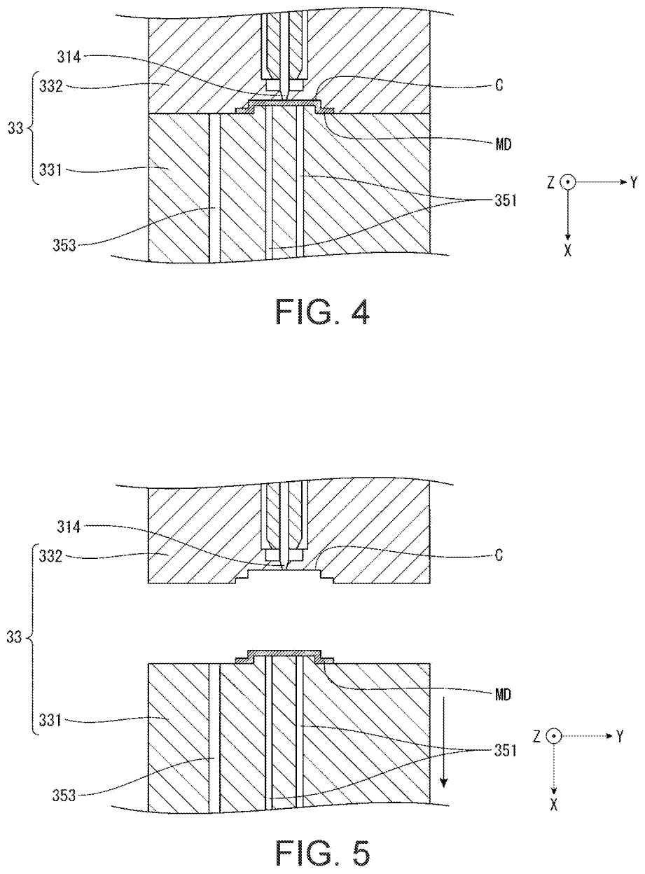

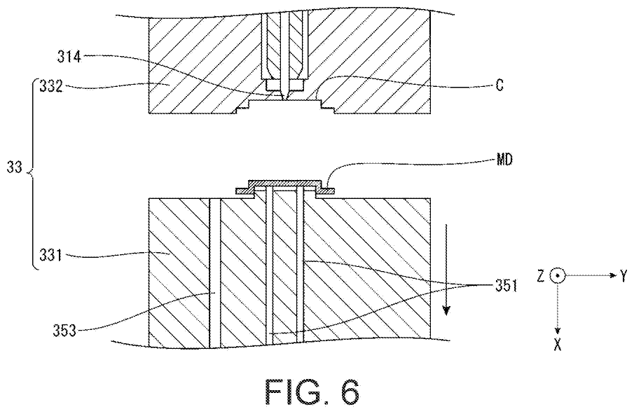

FIG. 1 is a front view showing an injection molding system according to a first embodiment. FIG. 2 is a plan view showing the inside of the injection molding system. FIG. 3 is a cross-sectional view of the injection molding machine. FIGS. 4 To 6 are cross-sectional views for explaining an operation of releasing a molded article from a mold. FIG. 7 is a flowchart for explaining a control method of the injection molding system.

As shown in FIG. 1, an injection molding system 1 has a housing 2. The housing 2 includes a first housing 21, a second housing 22 coupled to the X-axis direction plus side of the first housing 21, and a third housing 23 coupled to the X-axis direction minus side of the first housing 21. That is, the second housing 22 and the third housing 23 are disposed on both side of the first housing 21.

The first housing 21 includes a first accommodation space S1 and a first window 211 which is arranged on a front surface which is a side surface to the Y-axis direction minus side and is connected to the first accommodation space S1. The first window 211 is a double door type (a type in which both sides open) door having two doors. At least a part of the first window 211 is formed of a light transmissive member such as transparent glass or transparent plastic, and the inside of the first accommodation space S1 can be visually checked from the first window 211. The first housing 21 is provided with a sensor (not shown) for detecting opening and closing of the first window 211.

The first housing 21 includes a base section 212 below the first accommodation space S1. The base section 212 is composed of a cube-shaped base frame, a plate-shaped top plate 213 fixed to the base frame, and a bottom plate fixed to the lower side of the base frame. The base frame and the bottom plate are not shown. The first housing 21 is provided on the top plate 213 of the base section 212, and includes a cover 214 that covers a side surface on the Y-axis direction plus side and an upper surface that is a surface on the Z-axis direction plus side. The first accommodation space S1 is partitioned by the first window 211, the top plate 213, and the cover 214. Like the first window 211, at least a part of the cover 214 is made of a light transmissive member.

The second housing 22 can be attached to and detached from the first housing 21, and is coupled to the first housing 21 using various metal fittings such as bolts. The second housing 22 has a second accommodation space S2 and a second window 221 disposed on the front surface and is communicating with the second accommodation space S2. The second window 221 is a single-opening type door having a single door. At least a part of the second window 221 is formed of a light transmissive member such as transparent glass or transparent plastic, and the inside of the second accommodation space S2 can be visually checked from the second window 221. The second housing 22 is provided with a sensor (not shown) for detecting opening and closing of the second window 221.

The second housing 22 has a base section 222 below the second accommodation space S2. The base section 222 is composed of a cubic base frame, a plate-like top plate 223, which is fixed on the base frame, and the bottom plate, which is fixed to the lower side of the base frame. The base frame and the bottom plate are not shown. The second housing 22 includes a cover 224 that is provided on the top plate 223 of the base section 222 and that covers side surfaces in the Y-axis direction plus side and in the X-axis direction plus side and an upper surface, which is a surface in the Z-axis direction plus side. The second accommodation space S2 is partitioned by the second window 221, the top plate 223, and the cover 224. Like the second window 221, at least a part of the cover 224 is made of a light transmissive member.

The third housing 23 can be attached to and detached from the first housing 21, and is coupled to the first housing 21 using various metal fittings such as bolts. The third housing 23 has a third accommodation space S3 and a third window 231 that is arranged on the front surface and that is communicating with the third accommodation space S3. The third window 231 is a single-opening type door having a single door. Unlike the first window 211 and the second window 221, the third window 231 does not substantially transmit light, and the inside of the third accommodation space S3 cannot be visually checked through the third window 231. That is, the third accommodation space S3 is masked by the third window 231. The third housing 23 is provided with a sensor (not shown) for detecting opening and closing of the third window 231.

The third housing 23 has a base section 232 below the third accommodation space S3. The base section 232 is composed of a cube-shaped base frame, a plate-shaped top plate 233 fixed on the base frame, and a bottom plate fixed on the lower side of the base frame. The base frame and the bottom plate are not shown. The third housing 23 is provided on the top plate 233 of the base section 232, and includes a cover 234 that covers side surfaces in the Y-axis direction plus side and in the X-axis direction minus side and an upper surface that is a surface in the Z-axis direction plus side. The third accommodation space S3 is partitioned by the third window 231, the top plate 233, and the cover 234. The cover 234 does not substantially transmit light in the same manner as the third window 231, and serves to hide the third accommodation space S3 from sight.

The first housing 21 and the second housing 22 do not have a wall that partitions the first accommodation space S1 and the second accommodation space S2, and the first housing 21 and the third housing 23 do not have a wall that partitions the first accommodation space S1 and the third accommodation space S3. Therefore, in the housing, the first accommodation space S1, the second accommodation space S2, and the third accommodation space S3 are communicating with each other to form one large accommodation space S0. That is, in the injection molding system 1, one accommodation space S0 is surrounded by the first, second and the third housings 21, 22, and 23. Therefore, it is possible to suppress the entry of foreign matter such as dust and dirt into the accommodation space S0, and the erroneous entry of an operator. Therefore, the injection molding system 1 can manufacture a high-quality molded article MD and has high safety. Since it is possible to easily access the inside of the accommodation space S0 by opening the first, second, and the third windows 211, 221, and 231, it is possible to easily perform maintenance of various devices disposed in the accommodation space S0.

The housing 2 has been described above. Although not shown, the housing 2 includes wheels and a stopper, and the injection molding system 1 can be moved to an arbitrary installation place by using the wheels and can be fixed to the place by using the stopper.

Next, various devices disposed in the accommodation space S0 will be described. As shown in FIG. 2, the accommodation space S0 includes an injection molding machine 3 for molding the molded article MD, a material feeder 4 for feeding the material to the injection molding machine 3, a takeout device 5 for taking out the molded article MD that was formed by the injection molding machine 3 from the injection molding machine 3, a transport device 6 for transporting the molded article MD that was taken out by the takeout device 5, an inspection device 7 for performing an appearance inspection of the molded article MD, a stacking device 8 for collecting the inspected molded article MD that was inspected by the inspection device 7, a robot 9 for carrying out transport of the molded article MD from the transport device 6 to the inspection device 7 and transport of the molded article MD from the inspection device 7 to the stacking device 8, and a sensor 10 as a detection section for detecting an intruding object. The base section 212 of the first housing 21 includes a control device 11 that controls drive of each portion. Hereinafter, these devices will be described in order.

### Material Feeder 4

The material feeder 4 is a device for supplying a resin material to the injection molding machine 3. As shown in FIG. 2, the material feeder 4 is disposed in the third accommodation space S3 and is fixed to the top plate 233 of the third housing 23. Such a material feeder 4 includes a material dryer 41 and a material supply section 42. A pellet-like resin material used in the injection molding machine 3 is stored in the material dryer 41. The material stored in the material dryer 41 is dehumidified and dried in the material dryer 41, and is pressure-fed to a hopper 30 (to be described later) included in the injection molding machine 3 by the material supply section 42.

### Injection Molding Machine 3

The injection molding machine 3 is a device for molding a molded article MD from the resin material supplied from the material feeder 4. As shown in FIG. 2, the injection molding machine 3 is disposed in the first accommodation space S1 and is fixed to the top plate 213 of the first housing 21. The injection molding machine 3 is located on the X-axis direction plus side of the material feeder 4. Such an injection molding machine 3 is a lateral injection molding machine and includes the hopper 30, a plasticator 31, an injection control mechanism 32, a mold 33, a clamping device 34, an extrusion mechanism 35, and a collection box 36.

As shown in FIG. 3, the plasticator 31 includes a flat screw 311, a barrel 312, a heater 313, a nozzle 314, and a screw drive section 315. The flat screw 311 is rotated around the rotation axis RX by the screw drive section 315. A communication hole 316 is formed in the center of the barrel 312. The heater 313 is embedded in the barrel 312. The nozzle 314 is communicating with the communication hole 316, and a heater (not shown) is disposed around the nozzle 314. The temperature of the nozzle 314 is adjusted by controlling drive of the heater.

The hopper 30 supplies the resin material pressure-fed from the material feeder 4 to the flat screw 311. The resin material supplied to the flat screw 311 is guided from the communication hole 316 to the injection control mechanism 32 while being melted between the flat screw 311 and the barrel 312 by the rotation of the flat screw 311 and the heating of the heater 313.

The injection control mechanism 32 includes an injection cylinder 321, a plunger 322, and a plunger drive section 323. The injection cylinder 321 is a cylindrical member coupled to the communication hole 316, and the plunger 322 is disposed inside the injection cylinder 321. The plunger 322 is slid inside the injection cylinder 321 by the plunger drive section 323, and the molten resin introduced into the injection cylinder 321 from the communication hole 316 is force-fed from the nozzle 314 to the mold 33.

The mold 33 is also referred to as a “die” and includes a fixed mold 332 coupled to the nozzle 314 and a movable mold 331 that moves in the X-axis direction with respect to the fixed mold 332. The fixed mold 332 and the movable mold 331 are provided so as to face each other in the X-axis direction, and a cavity C, which is a space corresponding to the shape of the molded article MD, is formed therebetween. Further, although not shown, the mold 33 is coupled to a mold temperature control device that keeps the temperature of the mold 33 constant and that cools the molded article MD in the cavity C. The molten resin pressure-fed by the injection control mechanism 32 is injected into the cavity C from the nozzle 314, and the molten resin is cooled and cured in the cavity C, whereby the molded article MD is formed.

Such a mold 33 is opened and closed by the clamping device 34. The clamping device 34 includes a ball screw 342 coupled to the movable mold 331 and a mold drive section 341 that rotates the ball screw 342. When the mold drive section 341 rotates the ball screw 342, the movable mold 331 coupled to the ball screw 342 moves with respect to the fixed mold 332, and the mold 33 is opened and closed.

The molded article MD in the mold 33 is released from the mold 33 by the extrusion mechanism 35. The extrusion mechanism 35 has an ejector pin 351, a support plate 352, a support rod 353, a spring 354, an extrusion plate 355, and a thrust bearing 356. The ejector pin 351 is provided through the movable mold 331, and is fixed to the support plate 352. The support rod 353 is fixed to the support plate 352 and is inserted into a through hole formed in the movable mold 331. The spring 354 is disposed between the movable mold 331 and the support plate 352, and the support rod 353 is inserted into the spring 354. The spring 354 biases the support plate 352 so that the head of the ejector pin 351 forms a part of the wall surface of the cavity C during molding. The extrusion plate 355 is fixed to the support plate 352. The thrust bearing 356 is attached to the extrusion plate 355.

As shown in FIGS. 4 To 6, when the ball screw 342 is driven and the movable mold 331 moves to the X-axis direction plus side with respect to the fixed mold 332, the ball screw 342 contacts the thrust bearing 356 and the ejector pin 351 moves no further to the X-axis direction plus side. In this state, when the movable mold 331 is further moved to the X-axis direction plus side, only the movable mold 331 is moved to the X-axis direction plus side while the ejector pin 351 is in contact with the molded article MD, so that the ejector pin 351 protrudes into the cavity C to push out the molded article MD, and the molded article MD is released from the movable mold 331.

As shown in FIG. 2, the collection box 36 is disposed directly below the mold 33 and collects molded articles MD that were unintentionally dropped or intentionally dropped from the movable mold 331.

### Takeout Device 5

The takeout device 5 is a device for ejecting the molded article MD released from the movable mold 331 from the mold 33. As shown in FIG. 2, the takeout device 5 is disposed in the first accommodation space S1 and is fixed to the top plate 213 of the first housing 21. The takeout device 5 is positioned on the front side of the injection molding machine 3, that is, on the Y-axis direction minus side.

The takeout device 5 includes a hand 51 that sucks and grips the molded article MD and a stage 52 that moves the hand 51. The stage 52 has an X-axis stage 52x that slides in the X-axis direction with respect to the first housing 21, a Y-axis stage 52y that slides in the Y-axis direction with respect to the X-axis stage 52x, and a rotary stage 52θ that rotates around the Y-axis with respect to the Y-axis stage 52y, and the hand 51 is fixed to the rotary stage 52θ.

When the molding process is completed and the mold 33 is opened, the hand 51 enters between the movable mold 331 and the fixed mold 332 by drive of the stage 52, and further, the molded article MD released from the movable mold 331 is sucked and held. Next, the hand 51 is retracted from between the movable mold 331 and the fixed mold 332 by drive of the stage 52, and is in a position and posture for delivering the molded article MD to the transport device 6.

### Transport Device 6

The transport device 6 transports the molded article MD taken out by the takeout device 5. As shown in FIG. 2, the transport device 6 is disposed in the first accommodation space S1 and is fixed to the top plate 213 of the first housing 21. The transport device 6 is disposed on the X-axis direction plus side of the takeout device 5.

Such a transport device 6 has a loading stand 61 on which the molded article MD is placed and a stage 62 on which the loading stand 61 is slid in the X-axis direction. The stage 62 reciprocally moves the loading stand 61 between a first position for receiving the molded article MD from the takeout device 5 and a second position for delivering the molded article MD on the loading stand 61 to the robot 9. That is, the step of receiving the molded article MD from the takeout device 5 at the first position and the step of delivering the molded article MD to the robot 9 at the second position are repeated. As a result, the reception and the delivery of the molded article MD are repeatedly performed.

### Inspection Device 7

The inspection device 7 is a device that performs visual inspection of the molded article MD. As shown in FIG. 2, the inspection device 7 is disposed in the second accommodation space S2 and is fixed to the top plate 223 of the second housing 22. The inspection device 7 includes a test bed 71 on which the molded article MD is placed, a stage 72 that slides the test bed 71 in the Y-axis direction, a camera 73 that images the molded article MD on the test bed 71, a stage 75 that moves the camera 73 in the X-axis direction, the Y-axis direction, and the Z-axis direction, and an inspection section 74 that inspects the appearance of the molded article MD based on image data acquired by the camera 73.

The camera 73 is mounted on a brace and is located above the test bed 71. The brace is provided with a moving mechanism that is fixed to the top plate 223 and moves at least in the X-axis direction.

The stage 72 reciprocally moves the test bed 71 between a first position located below the camera 73 and a second position shifted to the Y-axis direction minus side from the camera 73 and close to the stacking device 8. Thus, by the test bed 71 moving to the first position and the second position, the transport time of the robot 9 is shortened, and also the robot 9 and the camera 73 do not approach each other, so it is possible to prevent interference between the robot 9 and the camera 73.

In such an inspection device 7, first, the molded article MD is placed on the test bed 71 at the second position by the robot 9. Next, the test bed 71 moves to the first position and the camera 73 is moved to a position suitable for imaging. Next, the camera 73 images the molded article MD on the test bed 71 from above, and when the imaging of the camera 73 is finished, the test bed 71 moves to the second position again. Next, the inspection section 74 inspects the appearance of the molded article MD on the basis of the image data acquired by the camera 73, and determines non-defective product/defective product. Molded articles MD judged to be non-defective product by the inspection section 74 are transported by the robot 9 to the stacking device 8, and molded articles MD judged to defective product are discharged by the robot 9 to a defective product discharge area (not shown) provided in the second housing 22.

### Stacking Device 8

The stacking device 8 is a device for stacking trays T containing the molded articles MD that were determined to be non-defective product by the inspection device 7. As shown in FIG. 2, the stacking device 8 is disposed in the second accommodation space S2 and is fixed to the base section 222 of the second housing 22. The stacking device 8 is located on the front side of the inspection device 7, that is, on the Y-axis direction minus side.

The stacking device 8 has a first elevator 81 and a second elevator 82. Empty trays T are stacked on the second elevator 82, and the empty tray T on the uppermost stage of the second elevator 82 is moved to the uppermost stage of the first elevator 81 by a sliding mechanism (not shown). When a predetermined number of non-defective molded articles MD are arranged on the tray T located at the uppermost stage of the first elevator 81, the tray T is lowered one stage by the first elevator 81, and the empty tray T at the uppermost stage of the second elevator 82 moves again to the uppermost stage of the first elevator 81. By repeating this, non-defective molded articles MD are collected.

### Robot 9

The robot 9 transports the molded article MD transported by the transport device 6 to the inspection device 7, and transports the molded article MD inspected by the inspection device 7 to the stacking device 8. The robot 9 is disposed in the second accommodation space S2 and fixed to the top plate 223 of the second housing 22. The robot 9 is positioned between the injection molding machine 3 and the inspection device 7.

Such the robot 9 is a SCARA robot (horizontal articulated robot), and includes a base 90 fixed to the second housing 22, a first arm 91 that rotates with respect to the base 90, a second arm 92 that rotates with respect to the first arm 91, and a spline shaft 93 disposed at a distal end section of the second arm 92. The spline shaft 93 is rotatable about its central axis with respect to the second arm 92 and is movable up and down along the central axis. A hand 94 for sucking and holding the molded article MD is attached to a lower end section of the spline shaft 93.

The robot 9 holds the molded article MD on the loading stand 61 at the second position by suction and places it on the test bed 71 at the second position. Then, molded articles MD that have been inspected by the inspection device 7 and determined to be non-defective product on the test bed 71 that has returned to the second position again are sucked and held, and placed on the tray on the first elevator 81. When there are molded articles MD judged to be defective product on the test bed 71, the molded articles MD judged to be defective product are sucked and held and discharged to a defective product discharge area. When the test bed 71 at the second position becomes empty in this way, the molded article MD on the loading stand 61 at the second position is sucked and held again, and is placed on the test bed 71 at the second position. By repeating such an operation, the appearance inspection by the inspection device 7 is repeatedly performed.

The robot 9 has been described above, but the robot 9 is not particularly limited as long as the robot 9 can perform the above-described movement, and may be, for example, a six axis robot (vertical articulated robot).

### Sensor 10

The sensor 10, as shown in FIG. 2, is disposed in the vicinity of the boundary between the first accommodation space S1 and the second accommodation space S2, and it detects an intruding object that intrudes to the injection molding machine 3 side from the second accommodation space S2 side, specifically detects the operator's arm or hand. As such the sensor 10, for example, a laser sensor, a camera sensor, or the like can be used. The sensor 10 is fixed to, for example, the top plate 213 or the top plate 223. Alternatively, the sensor 10 may be secured to the cover 214 or the cover 224.

### Control Device 11

The control device 11 is housed in the base section 212 of the first housing 21, and controls drive of the injection molding machine 3, the material feeder 4, the takeout device 5, the transport device 6, the inspection device 7, the stacking device 8, the robot 9, and the sensor 10 by interlocking with each other. The control device 11 is configured from, for example, a computer, and includes a processor (CPU) that processes information, a memory that is communicably coupled to the processor, and an external interface that is coupled to an external device. Various programs executable by the processor are stored in the memory, and the processor can read and execute the various programs and the like stored in the memory.

It should be noted that the control device 11 may be configured separately for each of the injection molding machine 3, the material feeder 4, the takeout device 5, the transport device 6, the inspection device 7, the stacking device 8, the robot 9, and the sensor 10. That is, the control device 11 may be configured to include a control section for controlling drive of the injection molding machine 3, a control section for controlling drive of the material feeder 4, a control section for controlling drive of the takeout device 5, a control section for controlling drive of the transport device 6, a control section for controlling drive of the inspection device 7, a control section for controlling drive of the stacking device 8, a control section for controlling drive of the robot 9, and a control section for controlling drive of the sensor 10, and an integrated control section for integrating these control sections, wherein the control sections are controlled in synchronization with each other based on commands from the integrated control section to control the target of control.

The overall configuration of the injection molding system 1 has been described above. Next, a control method of the injection molding system 1 will be described based on a flowchart of FIG. 7.

The control device 11 drives the injection molding system 1 as usual in a first state in which all of the first window 211, the second window 221, and the third window 231 are closed and safety is ensured. That is, the control device 11 drives each part of the injection molding machine 3, the material feeder 4, the takeout device 5, the transport device 6, the inspection device 7, the stacking device 8, the robot 9, and the sensor 10 as usual. Specifically, the material feeder 4 supplies resin material to the injection molding machine 3, the injection molding machine 3 molds a molded article MD, the takeout device 5 takes out the molded article MD from the injection molding machine 3, the transport device 6 transports the molded article MD taken out by the takeout device 5, the robot 9 transfers the molded article MD transported by the transport device 6 to the inspection device 7, the inspection device 7 inspects the molded article MD, and the robot 9 carries molded article MD judged to be non-defective product to the stacking device 8 and carries molded article MD judged to be defective product to a defective product discharge area. Hereinafter, the drive mode of the injection molding machine 3 in the normal state is also referred to as a first drive mode.

In this way, if while the injection molding system 1 is being driven in the first state in which all of the first window 211, the second window 221, and the third window 231 are closed, then the injection molding system 1 enters a second state in which the first window 211 is open, then the control device 11 determines that the degree of risk is “high”, and performs an emergency shutdown of the injection molding system 1. That is, the control device 11 performs an emergency shutdown of drive of the injection molding machine 3, the material feeder 4, the takeout device 5, the transport device 6, the inspection device 7, the stacking device 8, and the robot 9 Examples can be raised such as when the first window 211 is opened intentionally by an operator for maintenance, or opened unintentionally by vibration, impact, or the like. Thereafter, when the first window 211 is closed, the control device 11 promptly restarts drive of the injection molding machine 3, the material feeder 4, the takeout device 5, the transport device 6, the inspection device 7, the stacking device 8, and the robot 9. Thus, drive in the normal state is resumed. The same control is performed when, in addition to the first window 211, at least one of the second window 221 and the third window 231 is open.

The reason for performing such control is as follows. The first window 211 is located at the center of the housing 2, and the injection molding machine 3 and the robot 9 are driven particularly near the first window 211. Therefore, when the operator opens the first window 211 and extends his/her arm or hand into the accommodation space S0 from there, there is a high risk that his/her arm or hand will contact the injection molding machine 3 or the robot 9. In the injection molding machine 3, there is a risk that the operator's hand will be caught in the mold 33 or be burned by touching the mold 33, and with respect to the robot 9, there is a risk of injury by being hit by the arm moving at a high speed. Therefore, the injection molding machine 3 and the robot 9 are more dangerous than the other devices (the material feeder 4, the takeout device 5, the transport device 6, the inspection device 7, and the stacking device 8). Therefore, in this case, drive of all devices is stopped, including drive of the injection molding machine 3 and the robot 9 with which contact is possible. This makes it possible to enhance the safety of the injection molding system 1.

Note that even in the second state, for example, the inspection section 74 may continue to perform low-risk operations such as appearance inspection of the molded article MD.

If while the injection molding system 1 is being driven in the first state in which all of the first window 211, the second window 221, and the third window 231 are closed, the injection molding system 1 enters a third state in which the second window 221 is open, then the control device 11 determines a “medium risk” and although it continues drive of the injection molding machine 3 and the material feeder 4, it performs an emergency shutdown of drive of the other devices, that is, the takeout device 5, the transport device 6, the inspection device 7, the stacking device 8, and the robot 9. For example, the second window 221 may be intentionally opened by an operator for maintenance, or may be unintentionally opened by vibration, impact, or the like. Later, when the second window 221 is closed, the control device 11 promptly restarts drive of the takeout device 5, the transport device 6, the inspection device 7, the stacking device 8, and the robot 9. Thus, drive in the normal state is resumed. The same control is performed when the third window 231 is open in addition to the second window 221.

The reason for performing such control is as follows. The second window 221 is located on the X-axis direction plus side of the housing 2, and the robot 9 is driven near the second window 221. Therefore, when the worker opens the second window 221 and extends his/her arms or hands into the accommodation space S0, there is a high risk that his/her arms or hands will come into contact with the robot 9. On the other hand, since the injection molding machine 3 is distant from the second window 221, the risk that the arms or hands of the operator will come into contact with the injection molding machine 3 is low. Therefore, although drive of the injection molding machine 3 having low possibility of contact is continued, drive of the robot 9, which has a high risk of contact, and drive of the takeout device 5, the transport device 6, the inspection device 7, and the stacking device 8 are stopped. This makes it possible to enhance the safety of the injection molding system 1.

When drive of the takeout device 5 is stopped while the hand 51 is positioned between the movable mold 331 and the fixed mold 332, subsequent drive of the injection molding machine 3 is blocked. For this reason, the takeout device 5 stops driving after the hand 51 is retracted from between the movable mold 331 and the fixed mold 332. Similarly, when the robot 9 stops at a position where it interferes with the injection molding machine 3, the subsequent driving of the injection molding machine 3 is blocked. Therefore, the robot 9 is moved to a position where it does not interfere with the injection molding machine 3, and then drive of the robot 9 is stopped.

In the third state, when the sensor 10 detects an intruding object, the control device 11 stops drive of the injection molding machine 3 and the material feeder 4. As a result, it is possible to effectively suppress that the worker's arm or hand will come into contact with the injection molding machine 3 being driven, thereby enhancing the safety of the injection molding system 1.

If while the injection molding system 1 is being driven in the first state in which all of the first window 211, the second window 221, and the third window 231 are closed, the injection molding system 1 enters a fourth state in which the third window 231 is open, then the control device 11 determines that the degree of risk is “low” and continues to drive the injection molding machine 3, the material feeder 4, the takeout device 5, the transport device 6, the inspection device 7, the stacking device 8, and the robot 9. That is, drive in the normal state is continued. As described above, since drive in the normal state is continued even when the fourth state is reached, the step of determining whether the fourth state is reached may be omitted.

The reason for performing such control is as follows. The third window 231 is located on the X-axis direction minus side of the housing 2 and the material feeder 4 is disposed near the third window 231. Since the material feeder 4 is a device into which an operator introduces the resin material, the material feeder 4 is originally designed to be safe, and even if the material feeder 4 is touched during drive, the risk of injury or the like is extremely low. On the other hand, since the devices other than the material feeder 4 are distant from the third window 231, the risk that the arms or hands of the operator will come into contact with the devices other than the material feeder 4 is low. Therefore, drive of the injection molding machine 3, the material feeder 4, the takeout device 5, the transport device 6, the inspection device 7, the stacking device 8, and the robot 9 is continued as it is. Accordingly, even in a state where the third window 231 is opened in order to replenish the material feeder 4 with resin material, manufacture of the molded article MD is continued, and manufacturing efficiency of the molded article MD is increased.

As described above, the control device 11 shuts down drive of the injection molding machine 3 only when the first window 211 is opened, among the case where the first window 211 is opened, the case where the second window 221 is opened, and the case where the third window 231 is opened. Therefore, for example, the number of times the injection molding machine 3 is stopped is reduced compared to a case of performing simple control of stopping drive of the injection molding machine 3 when at least one of the first window 211, the second window 221, and the third window 231 is opened. This increases the production efficiency of the molded article MD. When the injection molding machine 3 stops, the molten resin remains in the injection molding machine 3, thereby causing a change in the quality or temperature of the molten resin, and the quality of the molded article MD to be molded thereafter may be degraded. Therefore, by reducing the number of times the injection molding machine 3 stops, it is possible to maintain the quality of the molded article MD.

Here, as described above, in the third state in which the second window 221 is open, the control device 11 continues to drive the injection molding machine 3 and the material feeder 4, but drives the injection molding machine 3 in a second drive mode, which is different from the first drive mode. Hereinafter, the second drive mode will be described.

In the second drive mode, for example, the number of the molded article MD per unit time is smaller than that in the first drive mode. That is, in the second drive mode, the time required for molding one molded article MD is longer than in the first drive mode. As described above, in this state, since drive of the takeout device 5 is stopped, the molded article MD cannot be taken out from the injection molding machine 3. Since the molded article MD that has not been taken out remains supported by the movable mold 331, no molded article MD can be newly molded in this state, and the injection molding machine 3 has to be stopped. Therefore, a molded article MD can be molded by the injection molding machine 3 only once from the point of time when ejection by the takeout device 5 is last performed. Therefore, by driving in the second drive mode in which the time required to mold one molded article MD is longer than in the first drive mode, there is more time available until the open second window 221 is closed, and the possibility that the second window 221 will be closed by the time one molded article MD is newly molded increases. Therefore, the possibility of returning from the second drive mode to the first drive mode without stopping drive of the injection molding machine 3 increases. As a result, deterioration of the quality of the molded article MD due to the stop of the injection molding machine 3 can be effectively suppressed.

The method of reducing the number of molded articles MD per unit time in the second drive mode to be smaller than the number of the molded articles MD per unit time in the first drive mode is not particularly limited. For example, as one method, the moving speed of the movable mold 331 at the time of opening and closing of the mold 33 in the second drive mode is made slower than the moving speed of the movable mold 331 at the time of opening and closing of the mold 33 in the first drive mode. As a result, the time required for opening and closing the mold 33 becomes longer, and the cycle time becomes longer accordingly. According to this method, by a simple control, the number of molded articles MD formed per unit time in the second drive mode can be made smaller than the number of molded articles MD formed per unit time in the first drive mode.

As another method, the temperature of the mold 33 in the second drive mode is made higher than the temperature of the mold 33 in the first drive mode. The temperature of the mold 33 can be adjusted by the above-described mold temperature control device. As a result, the time required for the molten resin to cure in the mold 33 becomes longer, and the cycle time becomes longer accordingly. According to this method, by a simple control, the number of molded articles MD formed per unit time in the second drive mode can be made smaller than the number of molded articles MD formed per unit time in the first drive mode.

The above two methods may be used by selecting one of them, or may be used in combination.

The number of molded articles MD per unit time in the second drive mode is made smaller than the number of molded articles MD per unit time in the first drive mode, and the temperature of the molten resin poured into the mold 33 in the second drive mode is made different from the temperature of the molten resin poured into the mold 33 in the first drive mode. Specifically, in the first drive mode, the molten resin is set to a temperature suitable for molding work, and in the second drive mode, the temperature is set to a temperature suitable for suppressing deterioration of the molten resin. As a result, it is possible to suppress deterioration of the resin material due to remaining inside the injection molding machine 3, and it is possible to maintain the quality of the molded article MD. Note that whether the temperature of the molten resin is less likely to deteriorate when the temperature of the molten resin is increased or, conversely, less likely to deteriorate when the temperature of the molten resin is decreased with respect to the first drive mode varies depending on the resin material to be used. Therefore, it may be appropriately set depending on the resin material to be used.

When the third state continues for a predetermined time, the control device 11 stops drive of the injection molding machine 3. This increases the safety margin of the injection molding system 1. Although the deterioration of the molten resin is suppressed by the control as described above, if the molten resin remains in the injection molding machine 3 for a long time, the deterioration of the molten resin may not be prevented. Therefore, in a case where the third state continues for a predetermined time, it is possible to effectively suppress the deterioration of the molded article MD's quality by stopping drive of the injection molding machine 3.

The injection molding system 1 has been described above. As described above, a control method for an injection molding system 1, the injection molding system 1 having a first housing 21 including a first accommodation space S1 and a first window 211 communicating with the first accommodation space S1, an injection molding machine 3 arranged in the first accommodation space S1, a second housing 22 coupled to the first housing 21, and having a second accommodation space S2 communicating with the first accommodation space S1 and a second window 221 communicating with the second accommodation space S2, a robot 9 that is disposed in the second accommodation space S2 and that performs an operation with respect to a molded article MD molded by the injection molding machine 3, and a control device 11 that controls driving of the injection molding machine 3 and the robot 9, the control method for the injection molding system 1 includes in a first state in which the first window 211 and the second window 221 are closed, driving the injection molding machine 3 in a first drive mode, in a second state in which the first window 211 is open, stopping the injection molding machine 3, and in a third state in which the second window 221 is open, driving the injection molding machine 3 in a second drive mode, wherein the second drive mode is different from the first drive mode. According to such a control method, the number of times the injection molding machine 3 stops can be reduced while ensuring safety. Therefore, it is possible to achieve both the safety of the injection molding system 1 and the quality maintenance of the molded article MD.

As described above, the robot 9 is driven in the first state, and the robot 9 is stopped in each of the second state and the third state. This results in the injection molding system 1 having high safety.

As described above, the number of the molded articles MD molded per unit time in the second drive mode is smaller than that in the first drive mode. That is, in the second drive mode, the time required for molding one molded article MD is longer than in the first drive mode. Accordingly, there is more time available until the second window 221 is closed, and the possibility that the second window 221 will be closed by the time one molded article MD is newly molded is increases. Therefore, the possibility of returning from the second drive mode to the first drive mode without stopping drive of the injection molding machine 3 increases. As a result, deterioration of the quality of the molded article MD can be effectively suppressed.

As described above, the injection molding machine 3 has the mold 33 including the fixed mold 332 and the movable mold 331 that moves relative to the fixed mold 332 to form a cavity C, which is a space for pouring molten resin between the movable mold 331 and the fixed mold 332, and the second drive mode has a slow moving speed of the movable mold 331 relative to the first drive mode. As a result, the time required for opening and closing the mold 33 becomes longer, and the cycle time becomes longer accordingly. According to this method, by a simple control, the number of molded articles MD formed per unit time in the second drive mode can be made smaller than the number of molded articles MD formed per unit time in the first drive mode.

As described above, the injection molding machine 3 has the mold 33 having a cavity C into which a molten resin is poured, and in the second drive mode, the temperature of the mold 33 is higher than that in the first drive mode. As a result, the time required for the molten resin to cure in the mold 33 becomes longer, and the cycle time becomes longer accordingly. According to this method, by a simple control, the number of molded articles MD formed per unit time in the second drive mode can be made smaller than the number of molded articles MD formed per unit time in the first drive mode.

As described above, the injection molding machine 3 has the mold 33 having a cavity C into which a molten resin is poured, and in the second drive mode, the temperature of the molten resin poured into the mold 33 is different from that in the first drive mode. Specifically, in the first drive mode, the molten resin is set to a temperature suitable for molding work, and in the second drive mode, the temperature is set to a temperature suitable for suppressing deterioration of the molten resin. As a result, it is possible to suppress deterioration of the resin material due to an increase in the time for which the resin material stays inside the injection molding machine 3, and it is possible to maintain the quality of the molded article MD.

As described above, when the third state continues for a predetermined time, the injection molding machine 3 is stopped. As a result, the safety of the injection molding system 1 is enhanced, and the deterioration of the molded article MD's quality can be effectively suppressed.

As described above, the injection molding system 1 includes the sensor 10 which is a detection section that detects an intruding object intruding into the injection molding machine 3 side from the second accommodation space S2 side, and stops the injection molding machine 3 in a case where the sensor 10 detects an intruding object in the third state. This increases the safety of the injection molding system 1.

As described above, an injection molding system 1 includes a first housing 21 having a first accommodation space S1 and a first window 211 communicating with the first accommodation space S1, an injection molding machine 3 arranged in the first accommodation space S1, a second housing 22 coupled to the first housing 21, and having a second accommodation space S2 communicating with the first accommodation space S1 and a second window 221 communicating with the second accommodation space S2, a robot 9 arranged in the second accommodation space S2 and configured to perform an operation with respect to a molded article MD molded by the injection molding machine 3, and a control device 11 that controls driving of the injection molding machine 3 and the robot 9. In a first state in which the first window 211 and the second window 221 are closed, the control device 11 drives the injection molding machine 3 in a first drive mode, in a second state in which the first window 211 is open, the control device 11 stops the injection molding machine 3, and in a third state in which the second window 221 is open, the control device 11 drives the injection molding machine 3 in a second drive mode, wherein the second drive mode is different from the first drive mode. According to such a configuration, the number of times the injection molding machine 3 is stopped can be reduced while ensuring safety. Therefore, it is possible to achieve both the safety of the injection molding system 1 and the quality maintenance of the molded article MD.

### Second Embodiment

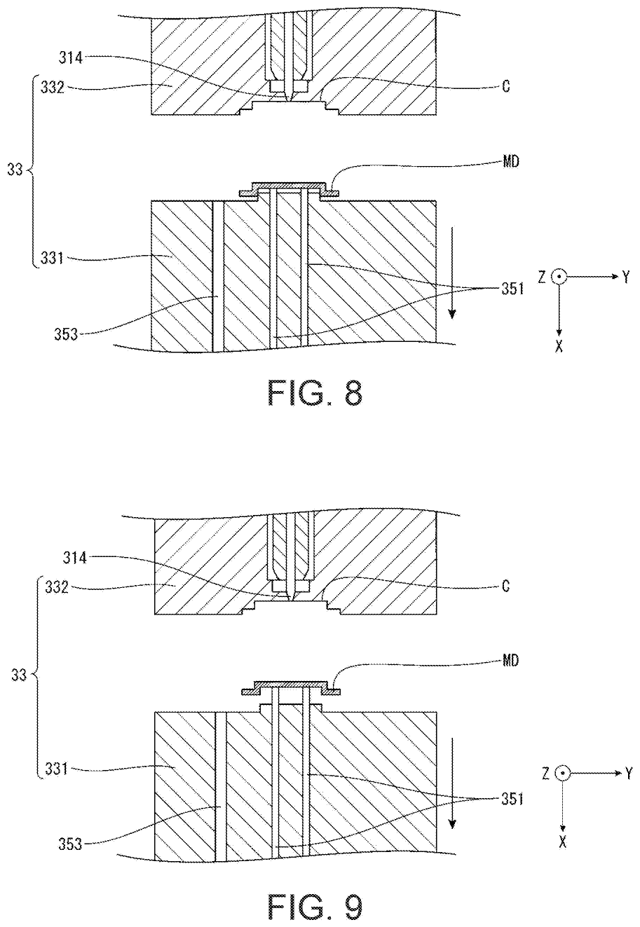

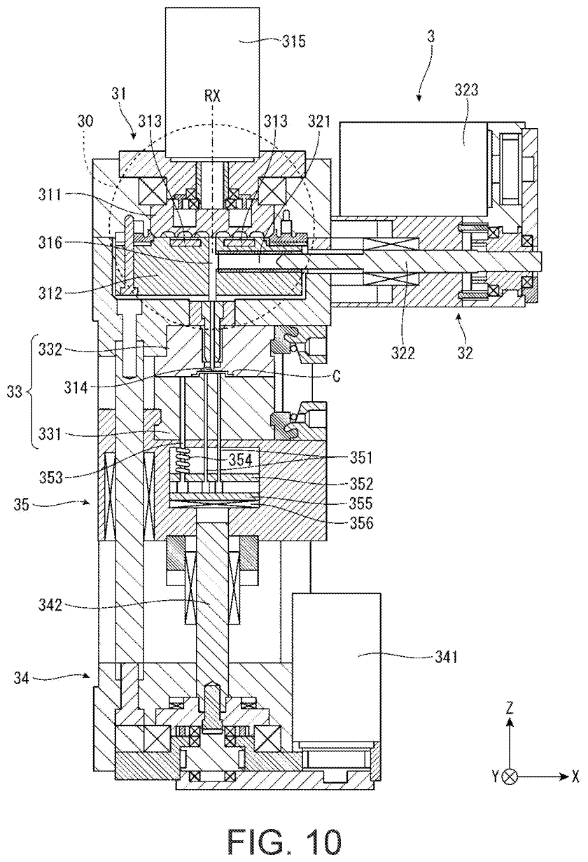

FIGS. 8 and 9 are cross sectional views for explaining a control method of the injection molding system according to the second embodiment.

The injection molding system 1 according to the present embodiment is the same as the injection molding system 1 of the first embodiment described above except that the second drive mode in the third state is different. In the following description, the injection molding system 1 of the present embodiment will be described focusing on differences from the above-described first embodiment, and the description of the same matters will be omitted. In each drawing of the present embodiment, the same reference numerals are given to the same configurations as those of the above-described first embodiment.

In the second drive mode of the present embodiment, the molded article MD is dropped from the mold 33. Specifically, when the molded article MD is taken out from the mold 33, in the first drive mode, as shown in FIG. 8, the ejector pin 351 caused to protrude into the cavity C to push out the molded article MD, and the molded article MD is released from the movable mold 331. In this state, the molded article MD is supported by the movable mold 331. On the other hand, in the second drive mode, as shown in FIG. 9, the amount of protrusion of the ejector pin 351 into the cavity C is made larger than that in the first drive mode, and the molded article MD is pushed out, separated from the movable mold 331, and dropped. The dropped molded article MD is collected in the collection box 36 disposed immediately below the mold 33.

In this way, by separating and dropping the molded article MD from the movable mold 331, the molded article MD can be repeatedly molded by the injection molding machine 3. Therefore, even in a state in which drive of the takeout device 5 is stopped, the injection molding machine 3 can be continuously driven during the third state, the molten resin does not remain in the injection molding machine 3, and the quality of the molded article MD can be maintained. The molded article MD collected in the collection box 36 is subjected to a check for damage due to dropping impact or the like, and if there is no damage, the appearance is inspected by the inspection device 7.

When the third state continues for a long time and a large number of molded articles MD are collected in the collection box 36, the time and labor required for checking the damage described above increase accordingly. Therefore, there is a risk that the disadvantage caused by this action for avoiding alteration of the molten resin in the injection molding machine 3 exceeds the disadvantage caused by the alteration of the molten resin inside by stopping the injection molding machine 3 (for example, the time and labor required for discharging the altered molten resin). Therefore, when the third state is continued for a predetermined time, the control device 11 stops drive of the injection molding machine 3. Accordingly, it is possible to suppress the disadvantage caused by the third state as small as possible.

In this respect, in the second drive mode, it is desirable to further reduce the number of the molded article MD per unit time as compared with the first drive mode as in the first embodiment described above. As a result, the number of molded articles MD collected in the collection box 36 can be reduced. Therefore, an increase in time and labor required for checking damage can be suppressed to be small.

As described above, in the control method of the injection molding system 1 of the present embodiment, the injection molding machine 3 has the mold 33 having the cavity C into which the molten resin is poured, and in the first drive mode, the molded article MD is released from the mold 33, and in the second drive mode, the molded article MD is dropped from the mold 33. Thus, the molded article MD can be repeatedly molded by the injection molding machine 3. Therefore, even in a state in which other devices are stopped, the injection molding machine 3 can be continuously driven during the third state, the molten resin does not remain in the injection molding machine 3, and the quality of the molded article MD can be maintained.

Such a second embodiment can also exhibit the same effects as the first embodiment described above. However, the present disclosure is not limited to this, and for example, the molded articles MD accumulated in the collection box 36 may be discarded. In this case, the time and labor required for checking the damage are not taken, but the resin material is wasted. Therefore, there is a risk that the disadvantage caused by wasteful consumption of the resin material may exceed the disadvantage caused by stopping the injection molding machine 3 and changing the quality of the molten resin therein.

### Third Embodiment

FIG. 10 is a cross-sectional view of an injection molding machine included in the injection molding system according to the third embodiment.

The injection molding system 1 according to the present embodiment is the same as the injection molding system 1 of the first embodiment described above except that the configuration of the injection molding machine 3 is different. In the following description, the injection molding system 1 of the present embodiment will be described focusing on differences from the above-described first embodiment, and the description of the same matters will be omitted. In the drawing of the present embodiment, the same reference numerals are given to the same configurations as those of the above-described embodiment.

As shown in FIG. 10, the injection molding machine 3 of the present embodiment is a vertical injection molding machine, and the movable mold 331 and the fixed mold 332 face each other in the Z-axis direction, and the movable mold 331 moves in the Z-axis direction with respect to the fixed mold 332.

Such a third embodiment can also exhibit the same effects as the first embodiment described above.

Although the control method of the injection molding system and the injection molding system have been described based on the embodiments shown in the drawings, the present disclosure is not limited thereto, and the configuration of each part can be replaced with an arbitrary configuration or an arbitrary process having the same function. Other arbitrary configurations or arbitrary processes may be added to the disclosure.

1. A control method for an injection molding system, the injection molding system including
a first housing having a first accommodation space and a first window communicating with the first accommodation space,
an injection molding machine arranged in the first accommodation space, a second housing coupled to the first housing, and having a second accommodation space communicating with the first accommodation space and a second window communicating with the second accommodation space,
a robot that is disposed in the second accommodation space and that performs an operation with respect to a molded article molded by the injection molding machine, and
a control device that controls driving of the injection molding machine and the robot,
the control method for the injection molding system comprising:
in a first state in which the first window and the second window are closed, driving the injection molding machine in a first drive mode;
in a second state in which the first window is open, stopping the injection molding machine, and
in a third state in which the second window is open, driving the injection molding machine in a second drive mode, wherein the second drive mode is different from the first drive mode.

2. The control method for the injection molding system according to claim 1, wherein
the robot is driven in the first state and the robot is stopped in both the second state and in the third state.

3. The control method for the injection molding system according to claim 1, wherein
in the second drive mode, a molded number of molded articles per unit time is smaller than in the first drive mode.

4. The control method for the injection molding system according to claim 3, wherein
the injection molding machine includes a mold having a fixed mold and a movable mold that moves relative to the fixed mold and that forms a space between itself and the fixed mold into which molten resin is poured and
in the second drive mode, the moving speed of the movable mold is slower than in the first drive mode.

5. The control method for the injection molding system according to claim 3, wherein
the injection molding machine includes a mold having a space into which molten resin is poured, and in the second drive mode, the temperature of the mold is higher than in the first drive mode.

6. The control method for the injection molding system according to claim 3, wherein
the injection molding machine includes a mold having a space in which molten resin is poured and the temperature of the molten resin poured into the mold in the second drive mode is different from that in the first drive mode.

7. The control method for the injection molding system according to claim 1, wherein
the injection molding machine includes a mold having a space into which a molten resin is poured, the molded article is released from the mold in the first drive mode, and the molded article is dropped from the mold in the second drive mode.

8. The control method for the injection molding system according to claim 1, wherein
the injection molding machine is stopped when the third state continues for a predetermined time.

9. The control method for the injection molding system according to claim 1, wherein
the injection molding system includes a detection section configured to detect an intruding object that intrudes into the injection molding machine side from the second accommodation space side, and in the third state, stops the injection molding machine when the detection section detects the intruding object.

10. An injection molding system comprising:
a first housing having a first accommodation space and a first window communicating with the first accommodation space;
an injection molding machine arranged in the first accommodation space;
a second housing coupled to the first housing, and having a second accommodation space communicating with the first accommodation space and a second window communicating with the second accommodation space;
a robot arranged in the second accommodation space and configured to perform an operation with respect to a molded article molded by the injection molding machine; and
a control device that controls driving of the injection molding machine and the robot, wherein
in a first state in which the first window and the second window are closed, the control device drives the injection molding machine in a first drive mode,
in a second state in which the first window is open, the control device stops the injection molding machine, and
in a third state in which the second window is open, the control device drives the injection molding machine in a second drive mode, wherein the second drive mode is different from the first drive mode.
